(19) United States
(12) Patent Application Publication
(10) Pub. No.: US 2015/0236506 A1
(43) Pub. Date: Aug. 20, 2015

(54) METHOD AND APPARATUS FOR PERFORMING A LOCAL CONTROL OF AN ENERGY RESOURCE

(71) Applicant: CATERVA GMBH, Pullach (DE)

(72) Inventors: Kolja Eger, Ottobrunn (DE); Roland Gersch, Muenchen (DE); Joerg Heuer, Oberhaching (DE); Martin Winter, Rosenheim (DE)

(73) Assignee: CATERVA GMBH, Pullach (DE)

(21) Appl. No.: 14/427,764

(22) PCT Filed: Apr. 5, 2013
(86) PCT No.: PCT/EP2013/057203

§ 371 Date: Mar. 12, 2015

(30) Foreign Application Priority Data
Sep. 14, 2012 (EP) 12184451.8

(51) Int. Cl. H02J 3/00; G05B 15/02

(52) U.S. Cl. CPC H02J 3/00; G05B 15/02

(57) ABSTRACT

Method and apparatus for performing a local control of an energy resource An energy resource controller (ERC) of an energy resource (ER) within an energy management system of a power supply grid (PSG), wherein said energy resource controller (ERC) is adapted to monitor a communication link (CL) to a control unit (CU) of said energy management system and to emulate after a loss or limitation of communication via said communication link (CL) has been detected a continued reception of control parameters and/or control limits from said control unit (CU) to perform a local control of the associated energy resource (ER) on the basis of the emulated control parameters and/or control limits according to an applied energy management policy (EMP).

### TECHNICAL BACKGROUND

The invention relates to a method and apparatus for performing a local control of an energy resource by an energy resource controller connected to a control unit of an energy management system of a power supply grid.

A power supply grid supplies distributed consumers with electrical power. These consumers can be located in distributed buildings where electrical devices such as washing machines or refrigerators consume electrical power as loads. The houses or buildings can comprise an inhouse grid which is connected to a local distribution grid which in turn can be connected via interconnects to a transmission grid of the power supply grid. In addition to the consuming entities consuming electrical power the use of distributed energy sources and energy storage devices increases significantly. Distributed storage devices can be formed by charge storage devices such as capacitors, by electrochemical storage devices such as accumulators or batteries, by mechanical storage devices such as flywheels and also by thermal storage devices. The distributed energy sources can comprise renewable energy sources such as wind farms or solar power plants. These renewable energy sources generate electrical power which is supplied to the power supply grid, wherein the amount of generated power depends on the local environment, in particular the weather and wind conditions. Accordingly, an energy resource connected to the power supply grid comprises an energy source which feeds electrical power into the power supply grid, an energy consuming load which draws electrical power from the power supply grid or a distributed storage device which is adapted to store electrical power.

Within an electrical power supply grid, the sum of the electrical power flowing into the grid, the electrical power flowing out of the grid and the power losses in the grid is zero. If this condition is not met, grid stability problems arise. Furthermore, all components of an electrical power supply grid have maximum rated capacities to carry power flows. If energy resources are connected so that actual power flows can exceed such rated capacities, capacity problems can arise. To avoid grid stability and capacity problems distributed storage devices can be provided locally, however, such storage devices are relatively expensive and must therefore be used efficiently, e.g. by combining multiple usages such as local energy buffering, local blackout prevention and support of the power supply grid.

In general, distributed energy resources comprising power sources, power consumers and energy storage devices can be controlled by energy resource controllers of an energy management system.

In a conventional energy management system the energy resource controllers of the distributed energy resources connected to the power supply grid can be connected via a communication link to a control unit which can be located in a central control operation center. This communication link can be a wired or wireless link via a communication network, for instance a DSL network or a radio network. The distributed energy resource controllers controlling the local energy resources are mostly connected via a public communication network to the remote control unit, since such a network is frequently already established at the site of the energy resource for other reasons such as provision of a mobile telephony service. This communication link is usually unreliable and there are times where no communication via the communication link to control the energy resource controllers by the remote control unit is possible. The communication link can be lost entirely or the bandwidth of the communication link can be reduced significantly. The reduction of the bandwidth can happen intentionally to save bandwidth or at random because of external influences. Even during times in which a communication link between the control unit and the energy resource controller of an energy resource is established, the bandwidth of the communication link might still be to low due to other energy resource controllers using the same communication link.

In some conventional implementations of energy management systems during times where the communication link to an energy resource controller of an energy resource is lost or limited there is no contribution of the affected energy resource to overcome for instance a grid stability or capacity problem in the power supply grid because this contribution of the energy resource controlled by the local energy resource controller cannot be controlled by the remote control unit via the lost or limited communication link. In other implementations of conventional energy management systems, energy resource controllers have been adapted to shut down operation of the local energy resource at certain fixed operation points of the power supply grid even without a communication link. As the power sum of energy resources controlled by such energy resource controllers has increased, this has lead to a potentially large grid stability problem should such a fixed operation point of the power supply grid be reached.

Accordingly, there is a need for an apparatus and a method which allows a contribution of a distributed energy resource even when the communication link between a control unit and the energy resource controller of said energy resource is lost or limited.

### SUMMARY OF THE INVENTION

The invention provides according to a first aspect an energy resource controller of an energy resource within an energy management system of a power supply grid,

wherein said energy resource controller is adapted to monitor a communication link to a control unit of said energy management system and to emulate after a loss or limitation of communication via said communication link has been detected a continued reception of control parameters and/or control limits from said control unit to perform a local control of the associated energy resource on the basis of the emulated control parameters and/or control limits according to an applied energy management policy.

In a possible embodiment of the energy resource controller according to the first aspect of the present invention, the energy resource controller is adapted to receive a set of energy management policies comprising at least one energy management policy from said control unit via said communication link and to store the received set of energy management policies in a local memory.

In a still further possible embodiment of the energy resource controller according to the first aspect of the present invention, said energy resource controller is connected to a policy management unit which comprises a processor adapted to process control parameters and/or control limits on the basis of rules of an applied energy management policy selected from said set of energy management policies stored in said local memory of said energy resource controller.

In a still further possible embodiment of the energy resource controller according to the first aspect of the present invention, before a loss or limitation of communication via said communication link is detected the policy management unit is adapted to either forward directly control parameters and/or control limits received from said control unit via said communication link to said energy resource controller or to derive control parameters and/or control limits from the control parameters and/or the control limits received from said control unit via said communication link and then to forward the derived control parameters and/or derived control limits to said energy resource controller depending on the rules of the selected and applied energy management policy.

In a still further possible embodiment of the energy resource controller according to the first aspect of the present invention, said energy resource controller is adapted to perform a local control of the associated energy resource as long as no loss or limitation of communication via said communication link is detected on the basis of the forwarded and/or derived control parameters and/or control limits which the energy resource controller receives from the respective policy management unit.

In a still further possible embodiment of the energy resource controller according to the first aspect of the present invention, in response to a detected loss or limitation of communication via said communication link said policy management unit is adapted to generate local control parameters and/or local control limits based on rules of an energy management policy selected from the active set of energy management policies received by the policy management unit from said control unit via said communication link before the loss or limitation of communication via said communication link has occurred and to output the generated local control parameters and/or local control limits to the energy resource controller to perform a local control of the associated energy resource.

In a still further possible embodiment of the energy resource controller according to the first aspect of the present invention, the policy management unit generates the local control parameters and/or local control limits based on the rules of the selected and applied energy management policy and/or on the basis of local measurements and/or on the basis of installation-dependent control limits.

In a still further possible embodiment of the energy resource controller according to the first aspect of the present invention, the local measurements comprise at least one measured value or time series for at least one of the following variables comprising a voltage frequency, a voltage, spectra of the voltage, currents, phase shifts between voltage and currents, and a state information of the energy resource, for example a state of charge or a state of supply.

In a still further possible embodiment of the energy resource controller according to the first aspect of the present invention, the local measurements comprise context data including current and/or forecast weather condition data at the location of the energy resource as well as time data indicating a local time, date, day of week and/or month at the location of the energy resource, and location data indicating a current geographical location of the energy resource.

In a still further possible embodiment of the energy resource controller according to the first aspect of the present invention, the local measurements comprise reliability data indicating a reliability of the communication link between the energy resource controller and the control unit and/or a reliability of the associated energy resource.

In a still further possible embodiment of the energy resource controller according to the first aspect of the present invention, the local measurements can also comprise power consumption data of local consumers and power generation data of local generators.

In a still further possible embodiment of the energy resource controller according to the first aspect of the present invention, the installation-dependent control limits comprise the maximum power output of the energy resource, the maximum power input of the energy resource, the maximum usable energy content of the energy resource, the maximum power flow of the local connection to the power supply grid and/or the maximum power that can be consumed by one or more local power consumers.

In a further possible embodiment of the energy resource controller according to the first aspect of the present invention, the applied energy management policy is selected from the active set of energy management policies having been received by the policy management unit from the control unit via said communication link before the loss or limitation of communication via said communication link has occurred, wherein the selection is performed depending on local measurements comprising measured grid parameters, measured context data, measured reliability data and/or measured consumption and/or generation data.

In a further possible embodiment of the energy resource controller according to the first aspect of the present invention, the energy resource controlled by said energy resource controller is adapted to feed electrical power into said power supply grid or to draw electrical power from said power supply grid or to store electrical power.

In a further possible embodiment of the energy resource controller according to the first aspect of the present invention, said communication link comprises a wired or wireless link via a communication network.

In a further possible embodiment of the energy resource controller according to the first aspect of the present invention, the communication link comprises a communication link via said power supply grid.

In a further possible embodiment of the energy resource controller according to the first aspect of the present invention, the energy resource is immobile and located at a fixed location and connected permanently to the power supply grid.

In a further possible embodiment of the energy resource controller according to the present invention, the energy resource controlled by said energy resource controller is movable between different locations and is connectable to said power supply grid.

In a further possible embodiment of the energy resource controller according to the first aspect of the present invention, said energy resource controller is adapted to detect a loss or limitation of communication of a monitored communication link to said communication unit by monitoring keep alive signals or keep alive messages transmitted by said control unit to said energy resource controller via said communication link or by monitoring the responses from said control unit to keep alive signals or keep alive messages transmitted by the energy resource controller.

The invention further provides according to a second aspect a method for performing a local control of an energy resource by an energy resource controller connected to at least one control unit of an energy management system of a power supply grid by means of a communication network comprising the steps of:

monitoring the communication link between the energy resource controller and the control unit via said communication network; and

emulating a continued reception of control parameters and/or control limits from said control unit by said energy resource controller to perform a local control of the associated energy resource if a loss or limitation of communication of the communication link between the energy resource controller of the energy resource and the control unit is detected.

In a possible embodiment of the method according to the second aspect of the present invention, if a loss or limitation of communication is detected local control parameters and/or local control limits are generated by a policy management unit connected to said energy resource controller based on rules of an energy management policy selected from a set of energy management policies received by the policy management unit from the control unit via this communication link before the loss or limitation of communication via this communication link has occurred.

According to a further aspect of the present invention, an energy resource is provided comprising an energy resource controller according to the first aspect of the present invention.

According to a further aspect of the present invention, a policy management unit of an energy resource controller according to the first aspect of the present invention is provided, wherein the policy management unit comprises a processor adapted to process control parameters and/or control limits on the basis of rules of an applied energy management policy selected from said set of energy management policies stored in a local memory of said energy resource controller.

According to a further aspect of the present invention, an energy management system of a power supply grid is provided comprising a control unit connected to a plurality of distributed energy resource controllers of energy resources via communication links, wherein each energy resource controller controls at least one local energy resource connected to a power supply grid managed by said energy management system using a selected energy management policy.

### BRIEF DESCRIPTION OF FIGURES

In the following, possible embodiments of the different aspects of the present invention are described in more detail with reference to the enclosed figures.

FIG. 1 is a block diagram for illustrating a possible implementation of an energy management system of a power supply grid according to an aspect of the present invention;

FIG. 2 shows a flow chart of a possible implementation of a method for performing a local control of an energy resource according to a further aspect of the present invention.

### DETAILED DESCRIPTION OF EMBODIMENTS

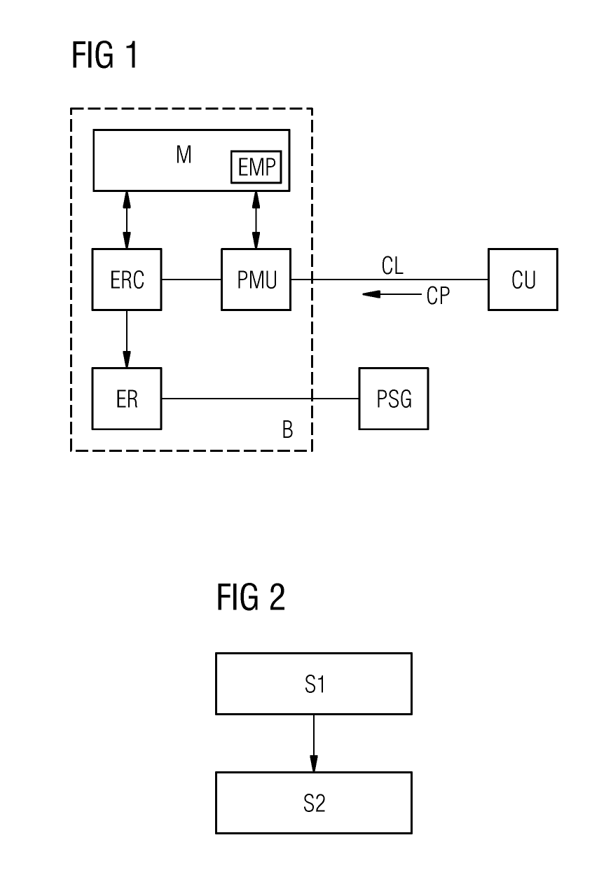

As can be seen in the block diagram in FIG. 1, an energy management system according to an aspect of the present invention is provided for managing a power supply grid PSG. The power supply grid PSG can comprise in a possible embodiment a transmission grid and a distribution grid to which local entities such as buildings or factories can be connected. The energy management system can comprise at least one control unit CU as illustrated in FIG. 1. The control unit CU can for instance be located at a central operation center of an operator. For each entity or building connected to the power supply grid PSG, several energy resources ER can be provided and connected to the power supply grid PSG. These energy resources ER can be formed by power generators adapted to feed electrical power into said power supply grid PSG. Further, the energy resources ER can comprise power consumers/loads which draw electrical power from said power supply grid PSG. Further, the energy resources ER can comprise storage devices which are adapted to store electrical energy such as batteries or accumulators. The storage devices can also comprise other storage devices adapted to store thermal energy or mechanical energy or electrical energy. One or several energy resources ER can be locally controlled by an energy resource controller ERC. The energy resource controller ERC can have access to a local memory M as illustrated in FIG. 1. In the energy management system at least some of the distributed energy resource controllers ERC are connected to a corresponding local policy management unit PMU which can have also access to the local memory M as shown in FIG. 1. In the shown implementation of FIG. 1, the policy management unit PMU is connected via a communication link CL to the remote control unit CU of the energy management system. The energy resource controller ERC and/or its policy management unit PMU are adapted to monitor the communication link to the control unit of the energy management system. The communication link CL shown in FIG. 1 can comprise a wired or wireless link via a communication network. A wired link can for instance comprise a DSL connection. Further, the communication link CL can be a wireless communication link, for instance a UMTS link of a mobile telephonynetwork. In this implementation, the energy resource controller ERC and its policy management unit PMU can comprise an antenna for wireless communication with the remote control unit CU.

In a still further possible alternative embodiment, the communication link CL can also be a communication link provided via the power supply grid PSG (powerline communication PLC).

If a loss or limitation of communication via its communication link CL is detected, the energy resource controller ERC itself or an integrated policy management unit PMU of the energy resource controller emulate a continued reception of control parameters and/or control limits from said control unit CU to perform a local control of the associated energy resource ER on the basis of the emulated control parameters and/or control limits according to an applied energy management policy. This energy management policy EMP is stored in the memory M of the energy resource controller ERC. In the energy management system as illustrated in FIG. 1, the energy resource controller ERC is adapted to receive a set of energy management policies and each set comprises at least one energy management policy. A set of energy management policies comprising one or several energy management policies is received by the energy resource controller ERC via said control link CL before a loss or limitation of the communication link CL occurs. The received set of energy management policies EMPs is stored by the receiving energy resource controller ERC locally in its memory M.

In the implementation shown in FIG. 1, the energy resource controller ERC is connected to a policy management unit PMU. The policy management unit PMU can comprise a processor which is adapted to process control parameters CP and/or control limits on the basis of rules R of an applied energy management policy EMP selected from the set of energy management policies stored in the memory M of the energy resource controller ERC.

In a possible embodiment, also a limitation of communication via said communication link is detected by the energy resource controller ERC or its associated policy management unit PMU. In a possible implementation, the energy resource controller ERC or its associated policy management unit PMU is adapted to detect a loss or limitation of the communication to the monitored communication link CL by monitoring keep alive signals or keep alive messages transmitted by said control unit CU to said energy resource controller ERC via the communication link CL. In an alternative embodiment, the loss or limitation of the communication via the communication link CL can also be detected by the control unit CU which signals the loss or limitation of the link to the energy resource controller ERC via another communication way, for instance via a powerline communication PLC using the power supply grid PSG connected to the energy resource ER controlled by the energy resource controller ERC. This signalling occupies less bandwidth than indication of control data and can therefore be performed via an alternative way such as powerline communication PLC.

Before a loss or limitation of communication via said communication link CL is detected the policy management unit PMU is adapted to either forward directly the control parameters CP and/or control limits received from said control unit CU via said communication link CL to said energy resource controller ERC or to derive itself control parameters and/or control limits from the control parameters CP and/or control limits received from said control unit CU via said communication link CL and then to forward the derived control parameters and/or derived control limits to said energy resource controller ERC depending on the rules R of the selected and applied energy management policy EMP read from the local memory M. Accordingly, as long as no loss or limitation of communication via said communication link CL is detected, the energy resource controller ERC is adapted to perform a local control of the associated energy resource ER on the basis of the forwarded or derived control parameters and/or control limits received by the energy resource controller ERC from its associated policy management unit PMU.

In contrast, if a loss or limitation of communication via said communication link CL is detected, for instance locally by the energy resource controller ERC or its associated policy management unit PMU, the policy management unit PMU generates local control parameters and/or local control limits based on the rules of an energy management policy EMP selected from the active set of energy management policies received by the policy management unit PMU from said control unit CU via said communication link CL before the loss or limitation of communication via said communication link CL has occurred. These generated local control parameters and/or local control limits are then output by the policy management unit PMU to its energy resource controller ERC which in turn performs a local control of the associated energy resource ER. The policy management unit PMU generates the local control parameters and/or local control limits based on the rules of the selected and applied energy management policy EMP. In a possible embodiment, the policy management unit PMU generates the local control parameters CP and/or local control limits also on the basis of local measurements m and/or on the basis of installation-dependent control limits. Local measurements can be provided by local sensors provided at the site of the energy resource ER. The generation or derivation of local control parameters CP and/or control limits can be performed in a possible implementation by using stored predetermined response functions or response curves with respect to local measurements m.

The local measurements can comprise in a possible embodiment a measured value or time series for different variables or parameters including a voltage frequency f of a voltage provided by the power supply grid PSG, a level of the supplied voltage as well as spectrum data of the supplied voltage. It can also comprise a current I provided by or to the power supply grid PSG as well as a phase relationship between current I and voltage V.

In a further possible embodiment, the local measurements used by the policy management unit PMU can further comprise context data. This context data can include current or forecast weather condition data at the location of the energy resource ER. Moreover, the context data comprises in a possible implementation time data indicating a local time, date, day of week and/or month at the location of the energy resource ER. In a further possible implementation, the context data further comprises location data indicating a current geographical location of the energy resource ER.

In a further possible embodiment, the local measurements used by the policy management unit PMU comprise also reliability data indicating a reliability of the communication link CL between the energy resource controller ERC and the control unit CU. The reliability data can also comprise data about the reliability of the associated energy resource ER.

In a further possible embodiment, the local measurements used by the policy management unit PMU can also comprise consumption data of local consumers and generation data of local generators.

In a further possible embodiment, the installation-dependent control limits used by the policy management unit PMU can comprise the maximum power output of the energy resource, the maximum power input of the energy resource, the maximum usable energy content of the energy resource, the maximum power flow of the local connection to the power supply grid and/or the maximum power that can be consumed by one or more local power consumers.

In a possible embodiment, the applied energy management policy EMP used by the policy management unit PMU is selected from the active set of energy management policies EMP having been received by the policy management unit PMU from the control unit CU via the still existing communication link CL before the loss or limitation of communication via said communication link has occurred. The selection of the energy management policy EMP from a group of energy management policies EMPs comprised in the active set of energy management policies is performed in a possible embodiment depending on local measurements at the location of the energy resource ER. For instance, a set of energy management policies can comprise a first energy management policy EMP1 for the day period and a different second energy management policy EMP2 for a night period. In this example, the selection of the energy management policy EMP from the set of energy management policies is performed depending on measured context data which comprises time data indicating a local time, date, day of week and/or month at the location of the energy resource ER. Accordingly, in this example, the policy management unit PMU selects an energy management policy EMP depending on the time when the communication loss or limitation is detected or notified to the policy management unit PMU. If the loss or limitation occurs at daytime, a first energy management policy EMP1 is selected, whereas when the loss of communication or the limitation of communication occurs during night another second energy management policy EMP2 is selected and activated. In other embodiments, the selection of the energy management policy EMP is performed depending on one or several local measurements comprising not only measured context data but also measured grid parameters, measured reliability data and/or measured consumption data.

In a possible implementation, a best effort approach is used to cope with a loss or limitation of the control communication to the control unit CU. In a best effort approach, the distributed energy resource ER is set by its energy resource controller ERC to a particular point of operation. As long as no new information data is received, the set operation point stays valid. This is also the case if a loss of control communication is detected or notified.

In a further possible approach, a secured operation is provided. For instance, with keep alive messages or signals the communication link operation is monitored. As soon as the communication link CL is broken or severely limited, the operation of the distributed energy resource ER is continued according to the selected energy management policy EMP.

The control unit CU is capable to transmit configuration data or energy management policies to the remote energy resource controllers ERCs of the distributed energy resources ER. The transmission of the energy management policies EMP can take place in a possible embodiment in a configuration phase of the power supply system. In a further possible embodiment, the transmission of the energy management policies EMP can also take place during operation of the distributed energy resources, for instance periodically. In a possible embodiment, there is a central control center comprising the control unit CU connected via a plurality of communication links CL to distributed energy resource controllers ERC. In an alternative embodiment, the energy management system comprises multiple distributed control units CUs which communicate with each other via a peer-to-peer mechanism. A peer-to-peer mechanism can be used to provide decision-taking capabilities in a reliable manner. In a possible embodiment, for instance if a communication loss with an energy resource controller ERC is detected, the distributed control units can negotiate a new energy management policy EMP for one or more available energy resources ER connected to the power supply grid PSG of said power supply system.

In a simple implementation, the energy resource ER controlled by an energy resource controller ERC can if its communication link has been lost or limited continue its operation to the last set point for a certain amount of time. In alternative implementations, the operation policy takes into account local measurements such as the local voltage, frequency or current at the location of the energy resource ER connected to the power supply grid PSG.

In a possible embodiment, the energy resource controller ERC monitors the communication link CL to the control unit CU and in case of loss of communication starts to calculate under consideration of its installation-dependent control limits and its actual operation state the explicit control limits and/or control parameters it would have received from the control unit CU if the communication over the communication link CL would have not been lost. The results of this calculation are then turned into actual control limits and/or control parameters taking into account the selected current energy management policy EMP. In a simple case, if the energy resource controller ERC accepts the results of the calculation as actual control limits and/or control parameters until a certain maximum time has elapsed since the loss or limitation of communication has been detected and does then discontinue its operation after this maximum time has elapsed. In a further possible embodiment, the energy resource controller ERC can cease a first operation such as a grid service after a maximum time has elapsed while other operations such as local energy buffering is continued under the control of the energy resource controller ERC indefinitely.

In a possible implementation of the energy management system, the energy management policy EMP received by the energy resource controller ERC can comprise different control parameters CP and control limits including maximum and minimum charging currents for local usage, electrical current being employed for grid balancing as a target value or a target function of voltage and frequency, the limits for a state of charge of a storage unit for local usage or equivalently, the limits for local energy usage. Further control parameters CP and control limits can comprise the expiry times and/or maximum times after which certain operation parts are discontinued by the energy resource controller ERC. Further, there can optionally be alternative sets of control parameters CP and/or control limits with different and later expiry times. At all times when a given control limit or control parameter CP is no longer valid but a not yet discontinued part of operation depends on it, the energy resource controller ERC can calculate a most likely value for the given control limit or control parameter CP.

In a possible implementation, the energy resource controller ERC can use local measurements of the state of the power supply grid PSG to calculate control limits and/or control parameters CP. For example, if the grid service performed after a loss or limitation of communication has caused a significant discharge of energy from the energy resource ER, the energy resource controller ERC can calculate that the control unit CU would have issued control parameters leading to a recharging of the energy resource ER from the power supply grid PSG thereafter.

In a still further possible embodiment, the energy resource controller ERC can also employ local measurements and/or forecasts of weather conditions to calculate the control limits and/or control parameters CP. For example, the energy resource controller ERC can gradually reduce the maximal charging current it can employ for buffering of a photovoltaic power if the weather forecast shows a change to more sunny weather to maximize its availability for grid services of the power supply grid PSG.

In a still further possible embodiment, the policy management unit PMU can base the selection of the energy management policy EMP to follow after a loss of communication has been detected on the information available to the control unit CU. For example, the control limits governing the rendering of the grid service at a given point in time can be set according to a worst-case estimate of the state of the energy resource at the given point in time based only on the information about the last state of the energy resource transmitted to the control unit CU before the loss of communication.

In the following, a simple example is given for illustrating the operation of an apparatus and method for performing a local control of energy resources ER by energy resource controllers.

### EXAMPLE

Three batteries B1-B3 in residential homes provide primary control power with a positive reserve of 30 kW (discharging the battery) and a negative reserve of 30 kW (charging the battery, 30 kW=100% in the following). The actual emitted (positive) or absorbed (negative) control power depends linearly on the deviation of the grid frequency from 50 Hz and is capped at 49.8 Hz and 50.2 Hz. The grid frequency is measured at each house. Each battery B can absorb and emit a maximum of 15 kW of power and store a maximum of 10 kWh of energy (10 kWh=100%). At a time t_0, the following is the pertinent state of the system:

| | B1 | B2 | B3 |
|---|---|---|---|
| SoC | 10% | 80% | 80% |
| Battery power output | 0% | 0% | 0% |
| Battery power input | 0% | 0% | 0% |
| Negative reserved control power (charge) | 50% | 25% | 25% |
| Positive reserved control power (discharge) | 0% | 50% | 50% |
| Grid frequency | 50.0 | 50.0 | 50.0 |

At this point, the connection between the control unit CU and the ERC of B1 is lost. In a conventional system, battery B1 immediately ceases operation and the control unit CU re-distributes the contribution of B1 to B2 and B3. The pertinent status of the system thus changes to the following:

| | B1 | B2 | B3 |
|---|---|---|---|
| SoC | 10% | 80% | 80% |
| Battery power output | 0% | 0% | 0% |
| Battery power input | 0% | 0% | 0% |
| Negative reserved control power (charge) | 0% | 50% | 50% |
| Positive reserved control power (discharge) | 0% | 50% | 50% |
| Grid frequency | 50.0 | 50.0 | 50.0 |

If now an oversupply in the power supply grid PSG occurs the status changes to:

| | B1 | B2 | B3 |
|---|---|---|---|
| SoC | 10% | 80% | 80% |
| Battery power output | 0% | 0% | 0% |
| Battery power input | 0% | 50% | 50% |
| Negative reserved control power (charge) | 0% | 50% | 50% |
| Positive reserved control power (discharge) | 0% | 50% | 50% |
| Grid frequency | 50.2 | 50.2 | 50.2 |

After several, e.g., 8 minutes of operation under these conditions, the state of the system is:

| | B1 | B2 | B3 |
|---|---|---|---|
| SoC | 10% | 100% | 100% |
| Battery power output | 0% | 0% | 0% |
| Battery power input | 0% | 0% | 0% |
| Negative reserved control power (charge) | 0% | 50% | 50% |
| Positive reserved control power (discharge) | 0% | 50% | 50% |
| Grid frequency | 50.2 | 50.2 | 50.2 |

This signals system failure: Neither B2 nor B3 are capable to work against the grid instability anymore (note that the current setup of the European grid requires the capability of primary control reserves to perform against a 50.2 Hz frequency for 15 minutes).

In contrast, with the method according to the present invention, if the connection to B1 is lost, the pertinent state is unchanged if the energy management policy EMP assigned to B1 is simply to continue in the same operational mode until 50% charge is reached or until one hour has passed, whichever comes earlier:

| | B1 | B2 | B3 |
|---|---|---|---|
| SoC | 10% | 80% | 80% |
| Battery power output | 0% | 0% | 0% |
| Battery power input | 0% | 0% | 0% |
| Negative reserved control power (charge) | 50% | 25% | 25% |
| Positive reserved control power (discharge) | 0% | 50% | 50% |
| Grid frequency | 50.0 | 50.0 | 50.0 |

If now the same oversupply in the power supply grid PSG as above occurs:

| | B1 | B2 | B3 |
|---|---|---|---|
| SoC | 10% | 80% | 80% |
| Battery power output | 0% | 0% | 0% |
| Battery power input | 50% | 25% | 25% |
| Negative reserved control power (charge) | 50% | 25% | 25% |
| Positive reserved control power (discharge) | 0% | 50% | 50% |
| Grid frequency | 50.2 | 50.2 | 50.2 |

After several, e.g., 8 minutes of operation, the state is as follows:

| | B1 | B2 | B3 |
|---|---|---|---|
| SoC | 30% | 90% | 90% |
| Battery power output | −50% | −25% | −25% |
| Negative reserved control power (charge) | 50% | 25% | 25% |
| Positive reserved control power (discharge) | 0% | 50% | 50% |
| Grid frequency | 50.2 | 50.2 | 50.2 |

The system is still fully operational. This is known to the control unit CU, as B1's state of charge can be calculated to be 30% from the frequency measurements of B2 or B3 and the policy for B1. Therefore, there is no need to reconfigure the system. As a further advantage battery B1 is much closer to 50% charge than after 8 minutes of operation before implementing the method according to the present invention.

After 15 minutes of operation, the state is as follows:

| | B1 | B2 | B3 |
|---|---|---|---|
| SoC | 48% | 99% | 99% |
| Battery power output | 0% | 0% | 0% |
| Battery power input | 50% | 25% | 25% |
| Negative reserved control power (charge) | 50% | 25% | 25% |
| Positive reserved control power (discharge) | 0% | 50% | 50% |
| Grid frequency | 50.2 | 50.2 | 50.2 |

The system is still fully operational after 15 minutes. Note that this is the current requirement for primary control power. The state of the system including the state of battery B1 is known to the controller since it can be calculated from the frequency measurement of battery B2 or battery B3 and the energy management policy EMP for battery B1.

In a possible embodiment of the energy management system according to the present invention, the energy resources ER comprise immobile energy resources which are located at fixed locations and which are connected permanently to the power supply grid PSG as well as mobile and movable energy resources ER which are movable between different locations and which are connectable to said power supply grid PSG. A mobile energy resource can be for instance an energy storage device which can be moved by a vehicle to different locations of the power supply grid PSG for purposes of moving the energy resource, but also for other purposes such as an e-car moving from one charging station to another. The movable energy resource ER can comprise an energy resource controller ERC which can be connected via a wireless link to the control unit CU. For these kinds of energy resources ER local measurements can be provided by sensor elements or detection devices including weather condition data, local time data and location data indicating a current geographical location of the movable energy resource. The movable energy resources have the advantage that they are allowed to meet local demands at different sections of the distributed power supply grid PSG.

According to a further aspect of the present invention, a method for performing a local control of an energy resource ER by an energy resource controller ERC connected to at least one control unit CU of an energy management system of a power supply grid PSG by means of a communication network is provided. FIG. 2 shows a flow chart of a possible implementation of such a method.

In a first step S1, the communication link CL between the energy resource controller ERC and the control unit CU via a communication network is monitored.

In a further step S2, a continued reception of control parameters CP and/or control limits CL from said control unit CU by said energy resource controller ERC is emulated to perform a local control of the associated energy resource ER if a loss or limitation of communication of the communication link CL between the energy resource controller ERC of the energy resource ER and the control unit CU is detected.

In a possible embodiment, if a loss or limitation of communication is detected, local control parameters CP and/or local control limits are generated by a policy management unit PMU connected to the energy resource controller ERC based on rules R of an energy management policy EMP. This energy management policy EMP is selected from a set of energy management policies received by the policy management unit PMU from the control unit CU via the communication link CL before a loss or limitation of the communication via this communication link CL has occurred and been detected.

In the energy management system according to the present invention, if a communication link CL is broken or severely limited, the energy resource controller ERC of the affected energy resource ER can make assumptions about how the control unit CU would have deployed the respective energy resource ER based on past deployments and actual conditions at the site of the respective energy resource ER. As this estimation has a certain likelihood to be accurate or close to accurate, by acting according to this estimation it is possible to provide a predictable contribution by the energy resource ER to a given application served under the control of the control unit CU and therefore a higher usage of the energy resource ER can be achieved when compared to a shutdown which is performed in a conventional network in case of loss of communication.

The communication link CL does not provide the only means of information transfer, but also the electrical power supply system measured at several points does provide transfer of information, if these measurements are used for estimation of operation behaviour of an energy resource ER after a communication link CL of an energy resource controller ERC of said energy resource ER is lost or severely limited. The same applies for measurements over time or of context data such as weather conditions which due to renewable energy resources do influence the electrical power supply system.

1. An energy resource controller of an energy resource within an energy management system of a power supply grid, wherein said energy resource controller is adapted to monitor a communication link to a control unit of said energy management system and to emulate after a loss or limitation of communication via said communication link has been detected a continued reception of control parameters and/or control limits from said control unit to perform a local control of the associated energy resource on the basis of the emulated control parameters and/or control limits according to an applied energy management policy.

2. The energy resource controller according to claim 1, wherein said energy resource controller is adapted to receive a set of energy management policies comprising at least one energy management policy from said control unit via said communication link and to store the received set of energy management policies in a memory.

3. The energy resource controller according to claim 2, wherein said energy resource controller is connected to a policy management unit which comprises a processor adapted to process control parameters and/or control limits on the basis of rules of an applied energy management policy selected from said set of energy management policies stored in said memory of said energy resource controller.

4. The energy resource controller according to claim 3, wherein before a loss or limitation of communication via said communication link is detected the policy management unit is adapted to either forward directly control parameters and/or control limits received from said control unit via said communication link to said energy resource controller or to derive control parameters and/or control limits from the control parameters and/or the control limits received from said control unit via said communication link and then to forward the derived control parameters and/or derived control limits to said energy resource controller depending on the rules of the selected and applied energy management policy.

5. The energy resource controller according to claim 1, wherein said energy resource controller is adapted to perform a local control of the associated energy resource as long as no loss or limitation of communication via said communication link is detected on the basis of the forwarded and/or derived control parameters and/or control limits which the energy resource controller receives from the respective policy management unit.

6. The energy resource controller according to claim 1, wherein in response to a detected loss or limitation of communication via said communication link said policy management unit is adapted to generate local control parameters and/or local control limits based on rules of an energy management policy selected from the last set of energy management policies received by the policy management unit from said control unit via said communication link before the loss or limitation of communication via said communication link has occurred and to output the generated local control parameters and/or local control limits to the energy resource controller to perform a local control of the associated energy resource.

7. The energy resource controller according to claim 6, where said policy management unit generates the local control parameters and/or local control limits based on the rules of the selected and applied energy management policy and/or on the basis of local measurements and/or on the basis of installation dependent control limits.

8. The energy resource controller according to claim 7, wherein said local measurements comprise at least one measured value or time series for at least one of the following variables: voltage frequency, voltage, spectra of the voltage, current, phase shift between voltage and current, and a state information of the energy resource, for example a state of charge or a state of supply, wherein said local measurements comprise context data including current and/or forecast weather condition data at the location of the energy resource, time data indicating a local time, date, day of week and/or month at the location of the energy resource, and location data indicating a current geographical location of the energy resource and/or wherein the local measurements comprise reliability data indicating a reliability of the communication link between the energy resource controller and the control unit and/or a reliability of the associated energy resource and/or wherein the local measurements comprise consumption data of local consumers and/or generation data of local generators.

9. The energy resource controller according to claim 7, wherein the applied energy management policy is selected from the last set of energy management policies having been received by the policy management unit from the control unit via said communication link before the loss or limitation of communication via said communication link has occurred depending on local measurements comprising measured grid parameters, measured context data and/or measured reliability data and/or measured consumption data.

10. The energy resource controller according to claim 1, wherein the energy resource is adapted to feed electrical power into said power supply grid or to draw electrical power from said power supply grid or to store power.

11. The energy resource controller according to claim 1, wherein said communication link comprises a wired or wireless link via a communication network and/or a communication link via said power supply grid.

12. The energy resource controller according to claim 1, wherein said energy resource is immobile and located at a fixed location and connected permanently to the power supply grid or mobile and movable between different locations and connectable to said power supply grid.

13. The energy resource controller according to claim 1, wherein said energy resource controller is adapted to detect a loss or limitation of communication of a monitored communication link to said communication unit by monitoring keep alive signals or keep alive messages transmitted by said control unit to said energy resource controller via said communication link.

14. A method for performing a local control of an energy resource by an energy resource controller connected to at least one control unit of an energy management system of a power supply grid by means of a communication network, comprising the steps of:
(a) monitoring the communication link between the energy resource controller and the control unit via said communication network; and
(b) emulating a continued reception of control parameters and/or control limits from said control unit by said energy resource controller to perform a local control of the associated energy resource if a loss or limitation of communication of the communication link between the energy resource controller of the energy resource and the control unit is detected.

15. The method according to claim 14, wherein if a loss or limitation of communication is detected local control parameters and/or local control limits are generated by a policy management unit connected to said energy resource controller based on rules of an energy management policy selected from a set of energy management policies received by the policy management unit from the control unit via this communication link before the loss or limitation of communication via this communication link has occurred.
